(19) United States
(12) Patent Application Publication
(10) Pub. No.: US 2009/0000135 A1
(43) Pub. Date: Jan. 1, 2009

(54) Service Entrance Level

(76) Inventor: Ronald Flowers, JR., Marina del Rey, CA (US)

Correspondence Address: FISH & RICHARDSON P.C., P.O. BOX 1022, MINNEAPOLIS, MN, 55440-1022, US

(21) Appl. No.: 12/147,320

(22) Filed: Jun. 26, 2008

Related U.S. Application Data
(60) Provisional application No. 60/937,362, filed on Jun. 26, 2007.

(51) Int. Cl. G01C 15/00

(52) U.S. Cl. 33/286

(57) ABSTRACT

A service entrance level includes a generally cylindrical housing that is at least partly sized to mate with an aperture. The generally cylindrical housing includes a planar face and a curved face. One or more level indicators are mounted to the housing, and the one or more level indicators are arranged to indicate the orientation of the housing in at least two axes. An illuminator, coupled to the housing, is arranged to emit a beam in a direction parallel to the curved face of the housing.

### CLAIM OF PRIORITY

This application claims priority under 35 U.S.C. §119(e) to U.S. patent application Ser. No. 60/937,362, filed on Jun. 26, 2007, the entire contents of which are hereby incorporated by reference.

### TECHNICAL FIELD

This disclosure relates to a service entrance level.

### BACKGROUND

Many homes and other various buildings have an electrical service panel, or more simply, a service panel. The service panel is a point of entry of electricity from the power company to a building (e.g., a single- or multi-unit residential or business dwelling). Buildings can have one main panel and several sub-panels for the distribution of power throughout the building. Power generally comes into a building from a service riser, connects to lugs within the service panel, and is split into separate circuits that run throughout the building.

A hub is generally a circular hole located at the top of the service panel. Hubs are typically one of several sizes ranging from half inch to four inches.

The service riser can be a hollow metal pipe that is generally installed in the hub of a service panel and travels vertically to the roof of a building. The pipe serves as a housing for electrical wires called service entrance conductors that are connected to the power company's wires (sometimes referred to as “service drop conductors”) and are fed through the pipe to the service panel, thereby bringing electricity into the building.

Service panels can be mounted on the outside of the building, either separate from or combined with an electrical meter, or on an inside wall, generally behind the meter. The main panel generally receives three incoming electrical service wires and routes smaller cables and wires to secondary subpanels and electrical circuits throughout a building.

The National Electrical Code and some local governing authorities require that a service riser be installed perpendicular to a service panel located on a wall of a building.

### SUMMARY

In some implementations, a service entrance level includes a generally cylindrical housing that is at least partly sized to mate with an aperture. The generally cylindrical housing includes a planar face and a curved face. One or more level indicators are mounted to the housing, and the one or more level indicators are arranged to indicate the orientation of the housing in at least two axes. An illuminator, coupled to the housing, is arranged to emit a beam in a direction parallel to the curved face of the housing.

The details of one or more implementations are set forth in the accompanying drawings and the description below. Other features and advantages will be apparent from the description and drawings, and from the claims.

### BRIEF DESCRIPTION OF DRAWINGS

This document describes these and other aspects in detail with reference to the following drawings.

FIG. 1 illustrates an implementation of a service panel installation.

FIG. 2 illustrates an implementation of a service panel installation.

FIGS. 3a-3c illustrate several views of an example service entrance level.

FIGS. 4a-4d illustrate several views of an implementation of a service entrance level.

FIGS. 5a and 5b illustrate two examples of stud holes formed with the aid of a service entrance level.

### DETAILED DESCRIPTION

The following is a description of preferred implementations, as well as some alternative implementations, of a device for indicating the location where a hole should be made for the installation of a service riser.

I. Overview

Implementations of a device for indicating the location where a hole should be made for the installation of a service riser can be used by the electrical trade to facilitate the installation of electrical service in a commercial or residential building. For reference herein, implementations of such a device are referred to as a “service entrance level.” The service entrance level guides an electrician through the process of installing a service riser substantially perpendicular to a service panel as may be required by National Electrical Code and local governing authorities. Once installed, the service riser carries electricity (e.g., sourced from a power company's wires located on poles at the exterior of the building) from the building's roof to the building's electrical service panel. Power can be distributed throughout the building by wires connected to the service panel.

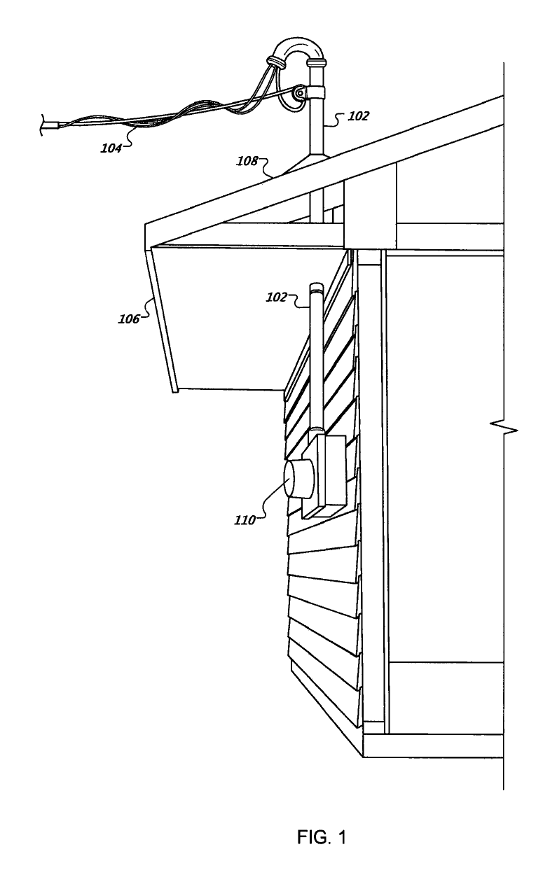

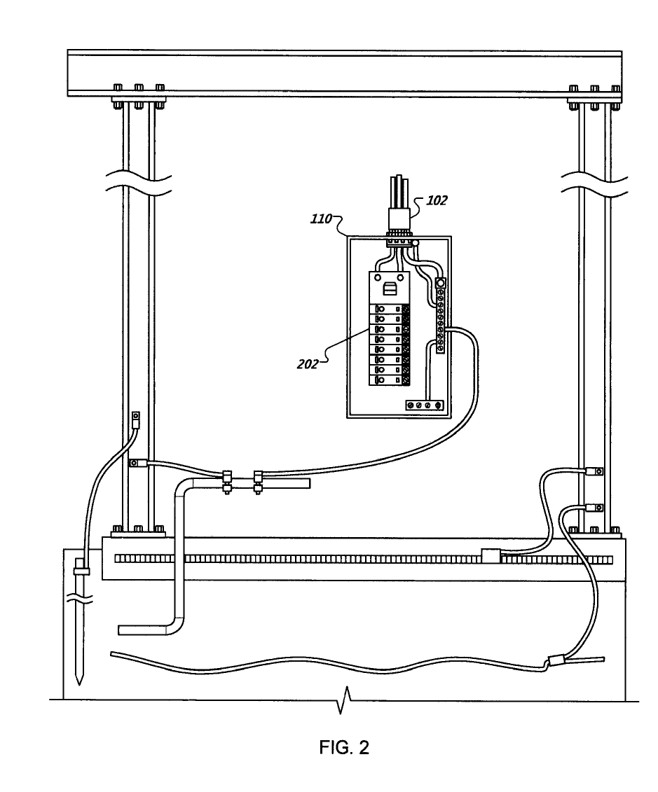

For example, FIG. 1 illustrates a service riser 102 that carries electricity, sourced from the power company's wires 104 located on poles at the exterior of a building 106, from a roof 108 through to a service panel 106 near ground level. FIG. 2 illustrates an example implementation where electrical power is distributed from the service panel 110 to wires that run throughout the building via a number of circuit breakers 202 or fuses.

II. Implementations of a Service Entrance Level

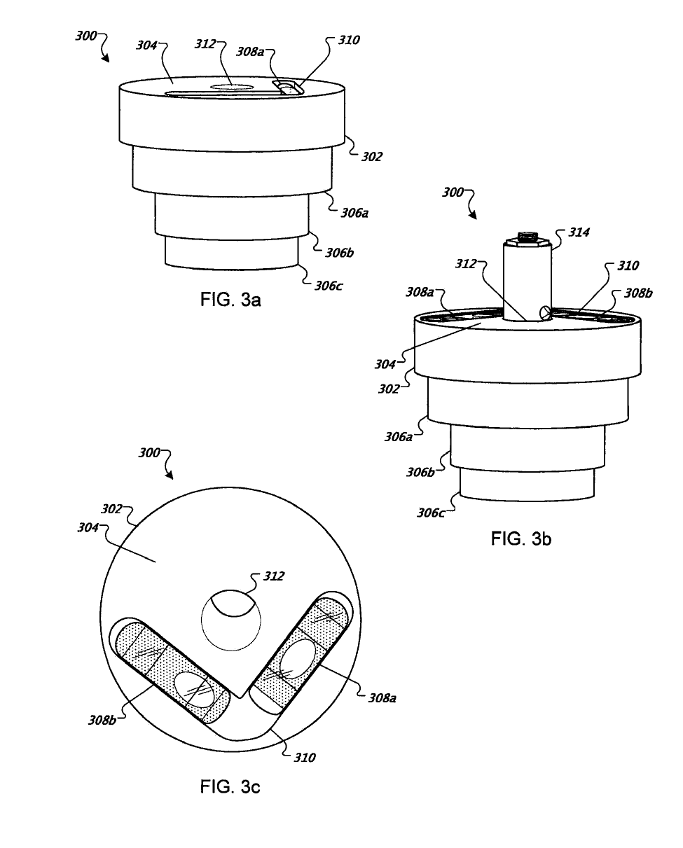

FIGS. 3a-3c illustrate several views of an implementation of a service entrance level 300. The service entrance level 300 includes a housing 302. The housing 302 is substantially cylindrical in shape, with a generally planar top surface 304. In some implementations, the diameter of the housing 302 varies in discrete steps 304a-304c along the length of the housing 302. For example, the diameter of the housing 302 may be stepped in two, three, four, or more discrete sizes to substantially accommodate two, three, four, or more sizes of hubs, respectively.

In some implementations, the diameter of the housing 302 can be sized to substantially mate with a single size of hub. In some implementations, the diameter varies along the length of the housing 302, thereby allowing the device to mate with apertures of various sizes. For example, the housing 302 can be substantially cone-shaped, starting at a point or a first diameter near the bottom of the housing 302 (in the orientation shown in FIG. 3a), and increases in diameter to a second diameter at a higher vertical location of the housing 302. In the conical configuration of the housing 302 of this example, the service entrance level 300 can be used with substantially any hub that has a diameter larger than the first diameter and smaller than the second diameter.

The service entrance level 300 also includes a level indicator 308a and a level indicator 308b. The level indicators 308a and 308b are arranged to indicate the orientation of the housing 302. In some implementations, the level indicators 308a and 308b are oriented approximately perpendicular to each other. For example, in the illustration of FIG. 3c the level indicator 308b is oriented at substantially 90 degrees from the level indicator 308a in the plane of the top surface 304.

In some implementations, the level indicators 308a and 308b are spirit levels (e.g., bubble levels). In some implementations, the level indicators 308a and 308b may be one or more circular bubble levels. For example, a circular bubble level is generally a flattened disk containing fluid and a bubble, and the disk is applied to a planar surface. By adjusting the planar surface to center the bubble in the face of the indicator, the planar surface may be indicated as being substantially horizontal in two dimensions.

The level indicators 308a and 308b are located in a recess 310 in the top surface 304. In some implementations, the indicators 308a and 308b may be located on the top surface 304.

The housing 302 includes a receptacle 312. The receptacle 312 is formed substantially along the vertical axis of the housing 302. The receptacle 312 is sized to accommodate an illuminator 314. The illuminator 314 is a device that can emit a beam or pattern of light to a point separated from the service entrance level 300, in a direction substantially parallel to the axis of the housing 302. In some implementations, the illuminator 314 can be a laser or other coherent light source. For example, a laser pointer or other laser module can be placed in the aperture 312 so the laser pointer can emit a beam of light along the axis of the housing 302, and illuminate a point at a distance from the service entrance level 300. In some implementations, the illuminator 314 can be a non-coherent light source, such as a light bulb or solid state light source (e.g., a light emitting diode). For example, the illuminator 314 can include a light bulb and one or more lenses and/or reflectors that can be used to focus light from the light bulb onto a point some distance away. In some implementations, the illuminator 314 can include a pattern mask to cause the illuminator to project a pattern onto a surface some distance away. While the illustrated illuminator 314 is a discrete from the housing 302, in some implementations, the illuminator can be made integrated into the housing 302, thereby forming a one-piece structure.

III. Use of a Service Entrance Level

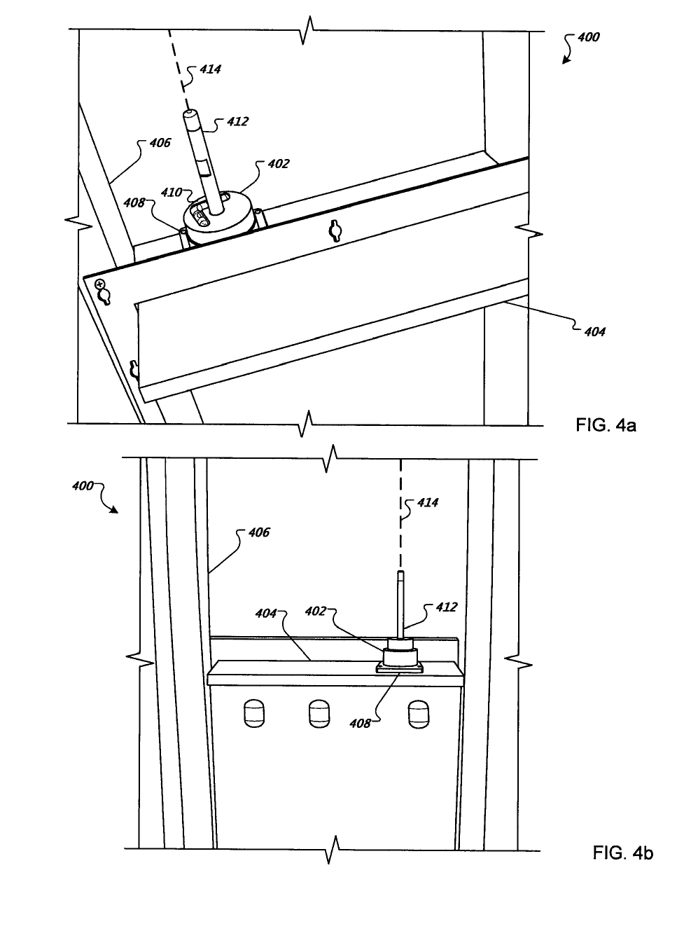

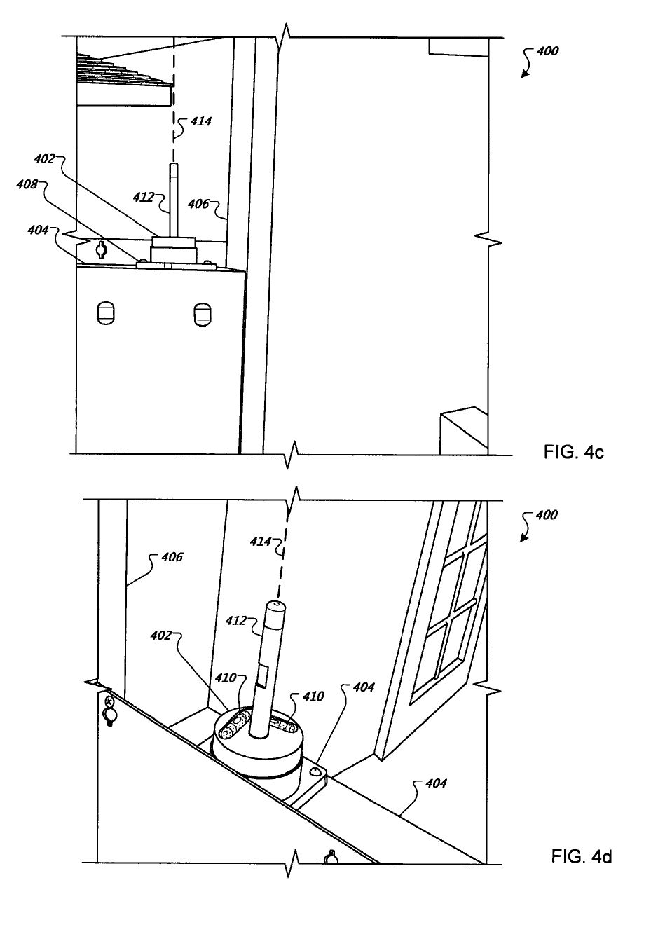

FIGS. 4a-4d illustrate several views of an implementation 400 of a service entrance level 402. In some implementations, the service entrance level 402 can be the service entrance level 302 of FIGS. 3a-3c. In the illustrated implementation, a service panel 404 is mounted on a wall 406 of a building.

The service entrance level 402 is inserted into a hub 408 on the service panel 404. A pair of level indicators 410, oriented substantially perpendicular to each other in the plane of the top surface of the service entrance level 402, can be used while orienting the service entrance level 402. For example, an electrician can observe the pair of level indicators 410 while orienting the service entrance level 402 to ensure that the top surface of the service entrance level 402 is substantially level relative to the Earth in two axes.

An illuminator 412 is oriented perpendicular to the top surface of the service entrance level 402. The illuminator 412 projects a beam 414, spot, pattern, or other luminous indication onto a surface some distance away. In some implementations, the illuminator can include a coherent light source such as a laser, or a non-coherent light source such as a focused beam from a light bulb or light emitting diode. By orienting the service entrance level 402 to be substantially level, the illuminator 412 is oriented to project the beam 414 upward at an angle that is substantially perpendicular to the top surface of the service panel 404.

In some implementations, the service entrance level 402 can be affixed to the outside of the hub 408. In some implementations, the service entrance level 402 may be affixed to an outer surface of the service panel 404. For example, the service entrance level 402 can be placed on the top surface of the service panel 404. In another example, the service entrance level can be affixed to the top or to a side surface of the service panel 404 by magnets, a suction cup, removable adhesives, or an electric charge.

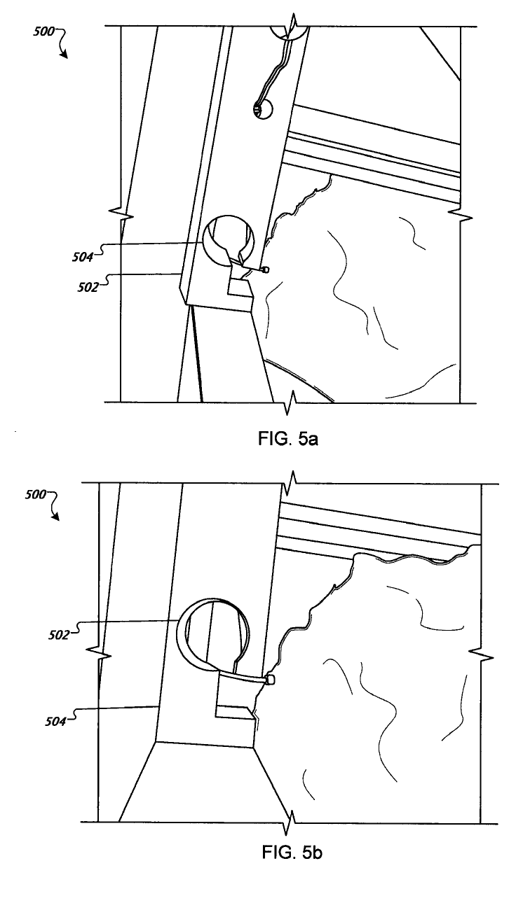

FIGS. 5a and 5b illustrate two views of and example 500 of stud holes formed with the aid of a service entrance level, such as the service entrance level 302 of FIGS. 3a-3c. FIGS. 5a and 5b show a stud 502 with a hole 504 bored through it, as seen looking upward, away from a point near a hub on a service panel.

By placing a service entrance level (not shown) into the hub of a service panel (not shown) and leveling it, an illuminator included in the service entrance level can be oriented to project a spot onto a surface of an object directly above the hub. In the example 500, the stud 502 is directly over the hub. The projected spot can be used to indicated a location for boring the hole 504.

In some implementations, after a hole (e.g., the hole 504) is bored, the illuminator can project its beam through the hole to illuminate a spot on another (e.g., higher) surface that may be bored as well. This process can repeat until a hole is bored through the building's roof or other upper surface. By using the projected spot(s), all the holes can be made substantially perpendicular to the service panel, and substantially in alignment with the hub. A service riser can then be passed through the holes to run substantially vertically from the rooftop to the hub, as is depicted by the service riser 102 of FIG. 1.

Although the previous examples have described the service entrance level in terms of electrical installations, other implementations exist. For example, the service entrance level can be used to guide the boring of holes used for plumbing, ductwork, communications cabling, or to guide the installation of other items. As such, the service entrance level is not limited to installation of a service riser. Instead, the service entrance level can be used to assist in the installation of any of type piping. For example, if a user needs to create a hole for the installation of a 15 cm diameter pipe though several surfaces, the user could (1) create a hole in the center of a first surface that aligns with the center of where the 15 cm pipe will be disposed, (2) insert the service entrance level in the hole (either with or without an adapter to conform to the hole) and (3) use the illumination (e.g., a laser) to indicate the center of the holes to be made on other surfaces.

A number of implementations have been described. Nevertheless, it will be understood that various modifications may be made without departing from the spirit and scope of the invention. Accordingly, other implementations are within the scope of the claims.

What is claimed is:

1. A device comprising:
a generally cylindrical housing wherein at least a portion of which is sized to mate with an aperture, the generally cylindrical housing comprising a planar face and a curved face;
one or more level indicators mounted to the housing, the one or more level indicators arranged to indicate the orientation of the housing in at least two axes; and
an illuminator, coupled to the housing, arranged to emit a beam in a direction parallel to the curved face of the housing.

2. The device of claim 1 wherein the housing has a length measured parallel to the curved face and a diameter measured parallel to planar face, further wherein the diameter of the housing varies along the length of the housing, thereby allowing the device to mate with apertures of various sizes.

3. The device of claim 2 wherein the diameter of the housing varies in discrete steps along the length of the housing.

4. The device of claim 1 wherein the illuminator comprises a laser.

5. The device of claim 1 wherein the illuminator comprises a coherent light source.

6. The device of claim 1 wherein the illuminator comprises a non-coherent light source.

7. The device of claim 1 wherein at least one level indicator comprises a spirit level.

8. The device of claim 1 wherein the one or more level indicators are arranged to indicate the orientation of the housing in at least two axes with respect to a reference orientation.

9. The device of claim 1 wherein at least one level indicator is mounted to the planar face of the housing.

10. The device of claim 1 wherein at least one level indicator is mounted in a recess in the planar face of the housing.

11. The device of claim 1 wherein the one or more level indicators comprise first and second levels mounted to the planar face of the housing, the first and second levels oriented approximately perpendicular to each other.

12. The device of claim 13 wherein the first and second levels are spirit levels.

13. The device of claim 1 wherein the illuminator is mounted to a receptacle disposed approximately in the center of the planar face.

14. The device of claim 1 wherein the planar face comprises a receptacle for receiving the illuminator, and further wherein the illuminator is removable from the housing.

15. A device for indicating the location where a hole should be made for the installation of a service riser, the device comprising:
a housing, wherein at least a portion of which is sized to mate with a circular aperture disposed on a first surface of an electrical service panel;
one or more level indicators mounted to the housing, the one or more level indicators arranged to indicate the orientation of the housing in at least two axes; and
an illuminator, coupled to the housing, arranged to emit a beam that is in a direction perpendicular to the first surface of the electrical service panel when the housing is mated with the circular aperture.

16. The device of claim 15 wherein the housing is generally cylindrical and has a length measured parallel to a curved face and a diameter measured parallel to a planar face, further wherein the diameter of the housing varies along the length of the housing, thereby allowing the device to mate with circular apertures of various diameters.

17. The device of claim 16 wherein the diameter of the housing varies in discrete steps along the length of the housing.

18. The device of claim 15 wherein at least one level indicator comprises a spirit level.

19. The device of claim 15 wherein the one or more level indicators are arranged to indicate the orientation of the housing in at least two axes with respect to a reference orientation.

20. The device of claim 12 wherein the housing comprises a planar face oriented perpendicular to a beam emitted by the illuminator.

21. The device of claim 20 wherein at least one level indicator is mounted to the planar face of the housing.

22. The device of claim 20 wherein at least one level indicator is mounted in a recess in the planar face of the housing.

23. The device of claim 15 wherein the one or more level indicators comprise first and second levels oriented approximately perpendicular to each other.

24. The device of claim 23 wherein the first and second levels are spirit levels.

25. The device of claim 20 wherein the one or more level indicators comprise first and second levels mounted to the planar face of the housing, the first and second levels oriented approximately perpendicular to each other.

26. The device of claim 25 wherein the first and second levels are spirit levels.

27. The device of claim 20 wherein the planar face comprises a receptacle for receiving the illuminator, and further wherein the illuminator is removable from the housing.

28. The device of claim 15 wherein the illuminator comprises a laser.

29. A device for indicating the location where a hole should be made for the installation of a service riser, the device comprising:
coupling means for mating with a circular aperture disposed on a first surface of an electrical service panel;
level indication means for indicating the orientation of the device in at least two axes; and
illumination means for emitting a beam that is in a direction perpendicular to the first surface of the electrical service panel when the device is mated with the circular aperture.
